(19) United States
(12) Patent Application Publication
(10) Pub. No.: US 2015/0229744 A1
(43) Pub. Date: Aug. 13, 2015

(54) Method and Device for Service Analysis

(71) Applicant: Huawei Technologies Co., Ltd., Shenzhen (CN)

(72) Inventors: Dekun Zheng, Shenzhen (CN); Haijiao Wang, Shenzhen (CN); Yagang Wang, Shenzhen (CN); Qiang You, Shenzhen (CN)

(21) Appl. No.: 14/696,201

(22) Filed: Apr. 24, 2015

Related U.S. Application Data
(63) Continuation of application No. PCT/CN2012/083413, filed on Oct. 24, 2012.

(51) Int. Cl. H04L 29/06; H04W 24/02; H04W 24/08

(52) U.S. Cl. CPC H04L 69/22; H04W 24/08; H04W 24/02; H04W 92/10

(57) ABSTRACT

Embodiments of the present invention provide a method and device for service analysis. The method for service analysis of the present invention includes obtaining deep packet inspection DPI information of a terminal, where the DPI information of the terminal is obtained by performing DPI on a first data packet transmitted between the terminal and a service provider; obtaining call history record CHR information of the terminal, where the CHR information of the terminal is obtained by performing call recording on an air interface link established between the terminal and a base station controller; and performing, according to the DPI information of the terminal and the CHR information of the terminal, analysis on a service transmitted between the terminal and the service provider.

This application is a continuation of International Application No. PCT/CN2012/083413, filed on Oct. 24, 2012, which is hereby incorporated by reference in its entirety.

### TECHNICAL FIELD

Embodiments of the present invention relate to communication technologies, and in particular, to a method and device for service analysis.

### BACKGROUND

In an MBB (mobile broadband) era, with fast development of mobile Internet services, communication operators have shifted their revenue emphasis from voice services to data services. For an operator, costs in developing a new user are four to five times the costs of maintaining an old user. Therefore, the operator needs to improve experience of data services to reduce an offline rate of a user.

In the prior art, a DPI (deep packet inspection) technology is mainly used to perform deep inspection on a data service packet transmitted between a user and a service provider (SP). Then, service features and service quality are evaluated and radio side resources and radio side environment are checked and optimized according to an evaluation result, so that experience of data services is improved.

During the implementation of the embodiments of the present invention, the inventor discovers that in the prior art, merely according to the evaluation result obtained by using the DPI technology, possible radio side factors need to be checked, radio side factors need to be located, which causes a low working efficiency.

### SUMMARY

Embodiments of the present invention provide a method and device for service analysis to locate radio side factors that affect data services and optimize the radio side factors, thereby increasing service quality of the data services and improving a working efficiency.

In a first aspect, an embodiment of the present invention provides a method for service analysis. Deep packet inspection (DPI) information of a terminal is obtained. The DPI information of the terminal is obtained by performing DPI on a first data packet transmitted between the terminal and a service provider. Call history record (CHR) information of the terminal is obtained by performing call recording on an air interface link established between the terminal and a base station controller. According to the DPI information of the terminal and the CHR information of the terminal, analysis on a service transmitted between the terminal and the service provider is performed.

With reference to the first aspect, the analysis is performed by obtaining a first Internet Protocol IP address of the first data packet, and obtaining a second IP address of a second data packet transmitted in the air interface link, associating the DPI information of the terminal with the CHR information of the terminal if the first IP address is the same as the second IP address, and performing analysis on the service transmitted between the terminal and the service provider according to the DPI information of the terminal and the CHR information of the terminal that have been associated.

With reference to the first aspect, the analysis is performed by obtaining an IP address of a first packet control function PCF, an IP address of a first packet data serving node (PDSN), and a KEY identifier of a first Generic Routing Encapsulation (GRE) protocol that correspond to the first data packet, and obtaining an IP address of a second PCF, an IP address of a second PDSN, and a KEY identifier of a second GRE protocol that correspond to a second data packet transmitted in the air interface link according to an A11 signaling during establishment of an A10 link after the air interface link is established. If the IP address of the first PCF is the same as the IP address of the second PCF, the IP address of the first PDSN is the same as the IP address of the second PDSN, and the KEY identifier of the first GRE protocol is the same as the KEY identifier of the second GRE protocol, the DPI information of the terminal is associated with with the CHR information of the terminal. Analysis on the service transmitted between the terminal and the service provider is performed according to the DPI information of the terminal and the CHR information of the terminal that have been associated.

With reference to the first aspect, performing the analysis comprises obtaining second terminal identifier information corresponding to a second data packet transmitted in the air interface link, during establishment of an A10 link between a PCF and a PDSN, obtaining an IP address of a first PCF, an IP address of a first PDSN, a KEY identifier of a first GRE protocol that correspond to the first data packet, and obtaining first terminal identifier information corresponding to the IP address of the first PCF, the IP address of the first PDSN, and the KEY identifier of the first GRE protocol, if the first terminal identifier information is the same as the second terminal identifier information, associating the DPI information of the terminal with the CHR information of the terminal, and performing, according to the DPI information of the terminal and the CHR information of the terminal that have been associated, analysis on the service transmitted between the terminal and the service provider.

With reference to the first aspect, the performing, according to the DPI information of the terminal and the CHR information of the terminal, analysis on a service transmitted between the terminal and the service provider includes obtaining second terminal identifier information corresponding to a second data packet transmitted in the air interface link; and obtaining a first IP address of the first data packet, and obtaining a third IP address and third terminal identifier information that are carried in a charging request message sent by a PDSN to an Authentication, Authorization and Accounting AAA; if the third of IP address is the same as the first IP address, determining the third terminal identifier information as terminal identifier information corresponding to the first data packet; and if the third terminal identifier information is the same as the second terminal identifier information, associating the DPI information of the terminal with the CHR information of the terminal; and performing a, according to the DPI information of the terminal and the CHR information of the terminal that have been associated, analysis on the service transmitted between the terminal and the service provider.

With reference to the first aspect, time when the first data packet is transmitted between the terminal and the service provider is between time of establishing the air interface link and time of releasing the air interface link.

With reference to the first aspect, the performing, according to the DPI information of the terminal and the CHR information of the terminal that have been associated, analysis on the service transmitted between the terminal and the service provider includes evaluating a key quality indicator KQI of the service according to the DPI information, where the KQI is used to indicate quality of the service and determining, according to the DPI information of the terminal and the CHR information of the terminal that have been associated, radio side factors that affect an exception of the KQI of the service.

With reference to the first aspect, performing the analysis includes obtaining, according to the DPI information of the terminal and the CHR information of the terminal that have been associated, radio behavior feature information of each service transmitted between the terminal and the service provider.

With reference to the first aspect, the radio behavior feature information includes any one of the following information or a combination of multiple pieces of the following information: penetration of radio connections, penetration of radio switching times, penetration of radio called times, penetration of radio connection duration, penetration of radio traffic, radio connections per Erlang ELR within period, radio connections per traffic within period, switching times per ELR within period, switching times per traffic within period, called times per ELR within period, and called times per traffic within period.

In a second aspect, an embodiment of the present invention provides a device for service analysis. A first obtaining module is configured to obtain deep packet inspection DPI information of a terminal. The DPI information of the terminal is obtained by performing DPI on a first data packet transmitted between the terminal and a service provider. A second obtaining module is configured to obtain call history record CHR information of the terminal. The CHR information of the terminal is obtained by performing call recording on an air interface link established between the terminal and a base station controller and associating and analyzing module is configured to perform, according to the DPI information of the terminal and the CHR information of the terminal, analysis on a service transmitted between the terminal and the service provider.

With reference to the second aspect, the associating and analyzing module is specifically configured to: obtain a a first Internet Protocol IP address of the first data packet, and obtain a second IP address of a second data packet transmitted in the air interface link; if the first IP address is the same as the second IP address, associate the DPI information of the terminal with the CHR information of the terminal; and performed, according to the DPI information of the terminal and the CHR information of the terminal that have been associated, analysis on the service transmitted between the terminal and the service provider.

With reference to the second aspect, the associating and analyzing module is specifically configured to obtain and IP address of a first packet control function PCF, an IP address of a first packet data serving node PDSN, and a KEY identifier of a first Generic Routing Encapsulation GRE protocol that correspond to the first data packet, and obtain, according to an A11 signaling during establishment of an A10 link after the air interface link is established, an IP address of a second PCF, an IP address of a second PDSN, and a KEY identifier of a second GRE protocol that correspond to a second data packet transmitted in the air interface link; if the IP address of the first PCF is the same as the IP address of the second PCF, the IP address of the first PDSN is the same as the IP address of the second PDSN, and the KEY identifier of the first GRE protocol is the same as the KEY identifier of the second GRE protocol, associate the DPI information of the terminal with the CHR information of the terminal; and performed, according to the DPI information of the terminal and the CHR information of the terminal that have been associated, analysis on the service transmitted between the terminal and the service provider.

With reference to the second aspect, the associating and analyzing module is specifically configured to: obtain and second terminal identifier information corresponding to a second data packet transmitted in the air interface link, obtain an IP address of a first PCF, an IP address of a first PDSN, and a KEY identifier of a first GRE protocol that correspond to the first data packet during establishment of an A10 link between the PCF and the PDSN, and obtain first terminal identifier information corresponding to the IP address of the first PCF, the IP address of the first PDSN, and the KEY identifier of the first GRE protocol; and if the first terminal identifier information is the same as the second terminal identifier information, associate the DPI information of the terminal with the CHR information of the terminal; and perform, according to the DPI information of the terminal and the CHR information of the terminal that have been associated, analysis on the service transmitted between the terminal and the service provider.

With reference to the second aspect, the associating and analyzing module is specifically configured to obtain second terminal identifier information corresponding to a second data packet transmitted in the air interface link, obtain a first IP address of the first data packet, and obtain a third IP address and third terminal identifier information that are carried in a charging request message sent by a PDSN to an Authentication, Authorization and Accounting AAA; if the third IP address is the same as the first IP address, determine the third terminal identifier information as terminal identifier information corresponding to the first data packet; if the third identifier information is the same as the second terminal identifier information, associate the DPI information of the terminal with the CHR information of the terminal; and performed, according to the DPI information of the terminal and the CHR information of the terminal that have been associated, analysis on the service transmitted between the terminal and the service provider.

With reference to the second aspect, time when the first data packet is transmitted between the terminal and the service provider is between time of establishing the air interface link and time of releasing the air interface link.

With reference to the second aspect, the associating and analyzing module is further configured to evaluate key quality indicator KQI of the service according to the DPI information, where the KQI is used to indicate quality of the service; and determine, according to the DPI information of the terminal and the CHR information of the terminal that have been associated, radio side factors that affect the KQI of the service.

With reference to the second aspect, the associating and analyzing module is further configured to obtain, according to the DPI information of the terminal and the CHR information of the terminal that have been associated, radio behavior feature information of each service transmitted between the terminal and the service provider.

With reference to the second aspect, the radio behavior feature information includes any one of the following information or a combination of multiple pieces of the following information: penetration of radio connections, penetration of radio switching times, penetration of radio called times, penetration of radio connection duration, penetration of radio traffic, radio connections per Erlang ELR within period, radio connections per traffic within period, switching times per ELR within period, switching times per traffic within period, called times per ELR within period, and called times per traffic within period.

In a third aspect, an embodiment of the present invention also provides a device for service analysis, including a memory and a processor, where the processor is configured to execute a code stored in the memory and the memory is configured to store a code that executes a method for service analysis. The method for service analysis includes: obtaining keep packet inspection DPI information of a terminal, where the DPI information of the terminal is obtained by performing DPI on a first data packet transmitted between the terminal and a service provider; obtain call history record CHR information of the terminal, where the CHR information of the terminal is obtained by performing call recording on an air interface link established between the terminal and a base station controller; and performing a, according to the DPI information of the terminal and the CHR information of the terminal, analysis on a service transmitted between the terminal and the service provider.

With reference to the third aspect, the performing, according to the DPI information of the terminal and the CHR information of the terminal, analysis on a service transmitted between the terminal and the service provider includes: obtaining a first Internet Protocol IP address of the first data packet, and obtaining a second IP address of a second data packet transmitted in the air interface link; it's the first IP address is the same as the second IP address, associating the DPI information of the terminal with the CHR information of the terminal; and performing, according to the DPI information of the terminal and the CHR information of the terminal that have been associated, analysis on the service transmitted between the terminal and the service provider.

With reference to the third aspect, the performing, according to the DPI information of the terminal and the CHR information of the terminal, analysis on a service transmitted between the terminal and the service provider includes: obtaining IP address of a first packet control function PCF, an IP address of a first packet data serving node PDSN, and a KEY identifier of a first Generic Routing Encapsulation GRE protocol that correspond to the first data packet, and obtaining, according to an A11 signaling during establishment of an A10 link after the air interface link is established, an IP address of a second PCF, an IP address of a second PDSN, and a KEY identifier of a second GRE protocol that correspond to a second data packet transmitted in the air interface link; it's the IP address of the first PCF is the same as the IP address of the second PCF, the IP address of the first PDSN is the same as the IP address of the second PDSN, and the KEY identifier of the first GRE protocol is the same as the KEY identifier of the second GRE protocol, associating the DPI information of the terminal with the CHR information of the terminal; and performing a, according to the DPI information of the terminal and the CHR information of the terminal that have been associated, analysis on the service transmitted between the terminal and the service provider.

With reference to the third aspect, the performing, according to the DPI information of the terminal and the CHR information of the terminal, analysis on a service transmitted between the terminal and the service provider includes: obtaining second terminal identifier information corresponding to a second data packet transmitted in the air interface link, obtaining an IP address of a first PCF, an IP address of a first PDSN, and a KEY identifier of a first GRE protocol that correspond to the first data packet during establishment of an A10 link between the PCF and the PDSN, and obtaining first terminal identifier information corresponding to the IP address of the first PCF, the IP address of the first PDSN, and the KEY identifier of the first GRE protocol; it's the first terminal identifier information is the same as the second terminal identifier information, associating the DPI information of the terminal with the CHR information of the terminal; and performing, according to the DPI information of the terminal and the CHR information of the terminal that have been associated, analysis on the service transmitted between the terminal and the service provider.

With reference to the third aspect, the performing, according to the DPI information of the terminal and the CHR information of the terminal, analysis on a service transmitted between the terminal and the service provider includes: obtaining a second terminal identifier information corresponding to a second data packet transmitted in the air interface link, obtaining a first IP address of the first data packet, and obtaining a third IP address and third terminal identifier information that are carried in a charging request message sent by a PDSN to an Authentication, Authorization and Accounting AAA; it's the third IP address is the same as the first IP address, determining the third terminal identifier information as terminal identifier information corresponding to the first data packet; his the third terminal identifier information is the same as the second terminal identifier information, associating the DPI information of the terminal with the CHR information of the terminal; and performing, according to the DPI information of the terminal and the CHR information of the terminal that have been associated, analysis on the service transmitted between the terminal and the service provider.

With reference to the third aspect, time when the first data packet is transmitted between the terminal and the service provider is between time of establishing the air interface link and time of releasing the air interface link.

With reference to the third aspect, the performing, according to the DPI information of the terminal and the CHR information of the terminal that have been associated, analysis on the service transmitted between the terminal and the service provider includes: evaluating a key quality indicator KQI of the service according to the DPI information, where the KQI is used to indicate quality of the service; and determining, according to the DPI information of the terminal and the CHR information of the terminal that have been associated, radio side factors that affect the KQI of the service.

With reference to the third aspect, the performing, according to the DPI information of the terminal and the CHR information of the terminal that have been associated, analysis on the service transmitted between the terminal and the service provider includes: obtaining, according to the DPI information of the terminal and the CHR information of the terminal that have been associated, radio behavior feature information of each service transmitted between the terminal and the service provider.

With reference to the third aspect, the radio behavior feature information includes any one of the following information or a combination of multiple pieces of the following information: penetration of radio connections, penetration of radio switching times, penetration of radio called times, penetration of radio connection duration, penetration of radio traffic, radio connections per Erlang ELR within period, radio connections per traffic within period, switching times per ELR within period, switching times per traffic within period, called times per ELR within period, and called times per traffic within period.

In the method and device for service analysis provided by the embodiments of the present invention, DPI information and CHR information of a terminal are obtained, and analysis is performed, according to the DPI information and the CHR information, on a service transmitted between the terminal and a service provider, so that radio side factors that affect data services can be located and the radio side factors are optimized, thereby increasing service quality of the data services and improve a working efficiency.

### BRIEF DESCRIPTION OF THE DRAWINGS

To illustrate the technical solutions in the embodiments of the present invention or in the prior art more clearly, the following briefly introduces the accompanying drawings required for describing the embodiments or the prior art. Apparently, the accompanying drawings in the following description show merely some embodiments of the present invention, and persons of ordinary skill in the art may still derive other drawings from these accompanying drawings without creative efforts.

FIG. 1 is a flowchart of a first embodiment of a method for service analysis according to the present invention;

FIG. 2 is a flowchart of a second embodiment of a method for service analysis according to the present invention;

FIG. 3 is a flowchart of a third embodiment of a method for service analysis according to the present invention;

FIG. 4 is a flowchart of a fourth embodiment of a method for service analysis according to the present invention;

FIG. 5 is a flowchart of a fifth embodiment of a method for service analysis according to the present invention;

FIG. 6 is a schematic structural diagram of a first embodiment of a device for service analysis according to the present invention; and

FIG. 7 is a schematic structural diagram of a third embodiment of a device for service analysis according to the present invention.

### DETAILED DESCRIPTION OF ILLUSTRATIVE EMBODIMENTS

To make the objectives, technical solutions, and advantages of the embodiments of the present invention more comprehensible, the following clearly and completely describes the technical solutions in the embodiments of the present invention with reference to the accompanying drawings in the embodiments of the present invention. Apparently, the described embodiments are merely a part rather than all of the embodiments of the present invention. All other embodiments obtained by persons of ordinary skill in the art based on the embodiments of the present invention without creative efforts shall fall within the protection scope of the present invention.

The embodiments of the present invention can be applicable to multiple communication systems. Using a CDMA (code division multiple access) system as an example, when a user terminal needs to implement data services through the CDMA system, a data service transmission channel needs to be established between the user terminal and a service provider. The process of establishing a data service transmission channel between the user terminal and the service provider in the CDMA system is as follows: After the user terminal establishes an air interface link with a BSS (base station subsystem), where the BSS includes a BTS (base transceiver station) and a BSC (base station controller), the BSC sends an A9 signaling to a PCF (packet control function) to request establishment of an A8 link; the PCF sends an A11 signaling to a PDSN (packet data serving node) to request establishment of an A10 link; the PDSN receives an A10 link establishment request and establishes an A10 link; the PCF establishes an A8 link, so that a connection between A8 and A10 are established successfully; the user terminal establishes a PPP (Point-to-Point Protocol) session connection with the PDSN; the PDSN allocates an IP (Internet Protocol, Internet Protocol) address to the user terminal; the PDSN requests, by sending a RADIUS (remote authentication dial in user service) packet to an AAA (Authentication, Authorization and Accounting), the AAA for charging the user terminal; finally, the user terminal can implement, by using the IP address, data transmission with the service provider. Persons of ordinary skill in the art may understand that the process of establishing a data service transmission channel is the same as the prior art. The process is not specifically described by the present invention.

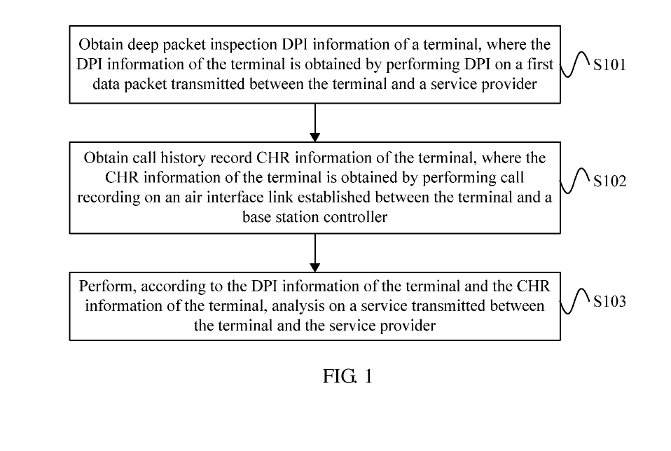

FIG. 1 is a flowchart of a first embodiment of a method for service analysis according to the present invention. As shown in FIG. 1, the method in this embodiment may include the following steps.

S101. Obtain deep packet inspection DPI information of a terminal, where the DPI information of the terminal is obtained by performing DPI on a first data packet transmitted between the terminal and a service provider.

After the data service transmission channel between the terminal and the service provider is established completely, the terminal can implement data packet transmission with the service provider. In this embodiment, the first data packet refers to all data packets transmitted between the terminal and the service provider in general. The DPI information of the terminal is obtained by performing deep packet inspection DPI on the first data packet; through the DPI, a service content analysis may also be performed on the first data packet on the basis of ordinary packet detection performed on the first data packet; a type of a data service is obtained through searching by using a feature word or measuring a service behavior; and service quality of the data service may also be obtained by measuring traffic distribution of the data service and service utilization of a user; and then DPI information of the terminal is generated according to such obtained information as a type of the data service and the quality of the data service. In this embodiment, the DPI information may also be considered as DPI information corresponding to the first data packet. The DPI information may include information related to services of the terminal, for example, the DPI information may include such information as an IP address of the terminal, an IP address of the service provider, an IP address of a PCF, an IP address of a PDSN, a KEY identifier of the GRE protocol, a service type, and traffic flow.

It should be noted that one feasible implementation manner of obtaining the DPI information is that a device for service analysis obtains the DPI information directly through the first data packet. Another feasible implementation manner is that a device for DPI analysis in the prior art obtains the DPI information through the first data packet, and then a device for service analysis obtains the DPI information from the device for DPI analysis.

S102. Obtain call history record CHR information of the terminal, where the CHR information of the terminal is obtained by performing call recording on an air interface link established between the terminal and a base station controller.

After the data service transmission channel between the terminal and the service provider is established, the terminal can implement data packet transmission with the service provider; then, a call recording is performed on the air interface link established between the terminal and the BSC, so as to obtain CHR (Call History Record, call history record) information, where the CHR information includes terminal information and all call related radio side information. One air interface link corresponds to one piece of CHR information. The DPI information obtained by performing deep inspection on the first data packet which is transmitted through the air interface link is DPI information corresponding to the air interface link, and the DPI information corresponds to CHR information of the air interface link.

It should be noted that there are many manners of obtaining the CHR information. For example, one feasible implementation manner is that a BSC in the prior art obtains the CHR information through a corresponding air interface link, and then a device for service analysis obtains the CHR information from the BSC.

S103. Perform, according to the DPI information of the terminal and the CHR information of the terminal, analysis on a service transmitted between the terminal and the service provider.

Due to shortage of radio resources, if the terminal and the service provider do not implement data packet transmission within a certain time, the air interface link is released to save radio resources. However, an A10 link and a PPP connection are not broken. The air interface link is re-established until the terminal and the service provider implements data transmission once again. Then, call recording is performed on this air interface link to obtain another piece of CHR information; deep packet inspection is performed on the first data packet which is transmitted after the air interface link is established, so as to obtain DPI information. The rest may be deduced in the same manner. CHR information and DPI information that correspond to each air interface link can be obtained.

Specifically, because one piece of DPI information corresponds to one piece of unique CHR information, CHR information corresponding to the DPI information can be matched according to an IP address of the terminal, or an IP address of a PCF, an IP address of a PDSN and a KEY identifier of the GRE protocol in the A10 link, or terminal identifier information, and then analysis is performed, according to the obtained DPI information of the terminal and corresponding CHR information of the terminal, on a service transmitted between the terminal and the service provider. Specifically, different DPI information corresponding to a same air interface link of a same terminal may be associated with CHR information corresponding to the same air interface link according to the DPI information of the terminal and the CHR information of the terminal that are obtained within an evaluation period. Because the service type and service quality can be analyzed according to the DPI information and the CHR information may carry radio side information, the associated information includes information of both the service and the radio side.

In the case where the service quality is poor, radio side factors that affect the service quality can be quickly located by using the CHR information, and then the radio side factors are optimized, thereby increasing the service quality of the service. It should be noted that during the specific implementation, to analyze the services more accurately, associated DPI information and CHR information that correspond to different terminals should be obtained based on at least one terminal.

In the method for service analysis provided by the first embodiment of the present invention, DPI information and CHR information of a terminal are obtained, and analysis is performed, according to the DPI information and the CHR information, on a service transmitted between the terminal and a service provider, so that radio side factors that affect data services can be located and the radio side factors are optimized, thereby increasing service quality of the data services and improve a working efficiency.

The technical solution of the method embodiment illustrated in FIG. 1 is detailed hereinafter by using four specific embodiments.

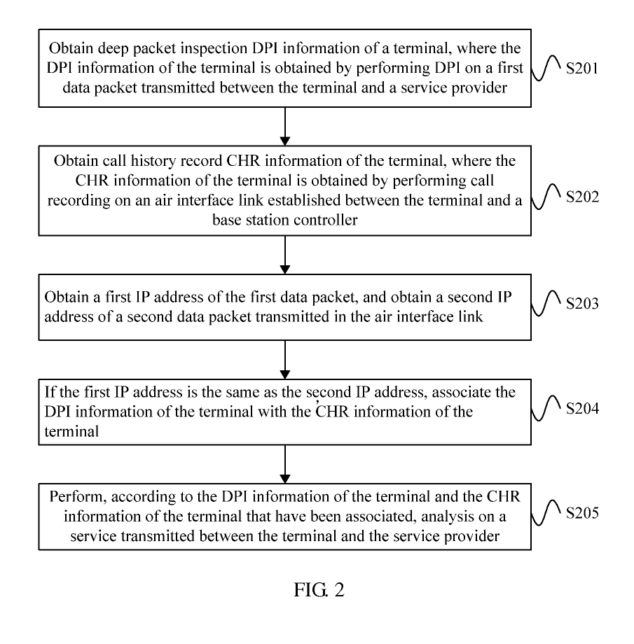

FIG. 2 is a flowchart of a second embodiment of a method for service analysis according to the present invention. As shown in FIG. 2, in this embodiment, DPI information may be associated with CHR information by using an IP address of a terminal. The method may include the following steps.

S201. Obtain deep packet inspection DPI information of a terminal, where the DPI information of the terminal is obtained by performing DPI on a first data packet transmitted between the terminal and a service provider.

S202. Obtain call history record CHR information of the terminal, where the CHR information of the terminal is obtained by performing call recording on an air interface link established between the terminal and a base station controller.

S203. Obtain a first IP address of the first data packet, and obtain a second IP address of a second data packet transmitted in the air interface link.

Specifically, an IP address is allocated to the terminal at an NCP (Network Control Protocol) phase during establishment of a PPP session. As an IP address for data transmission between the terminal and the service provider, the IP address is carried in a data packet transmitted between the terminal and the service provider. In addition, in a whole PPP session period, the IP address of the terminal remains unchanged. Therefore, an IP address of the terminal carried in the first data packet can be obtained from the DPI information which is obtained by performing DPI on the first data packet transmitted between the terminal and the service provider, where the IP address of the terminal is called a first IP address. In this embodiment, a data packet transmitted in the air interface link is called a second data packet. Because the BSC can parse out an IP address of the terminal carried in the second data packet and record the IP address of the terminal in CHR information corresponding to the air interface link, where the IP address of the terminal is called a second IP address. The second IP address of the second data packet can be obtained through the CHR information of the air interface link.

S204. If the first IP address is the same as the second IP address, associate the DPI information of the terminal with the CHR information of the terminal.

Whether the obtained first IP address is the same as the second IP address is determined; if the first IP address is different from the second IP address, it indicates that the first data packet and the second data packet are data packets transmitted between different terminals and the service provider, and therefore the DPI information cannot be associated with the CHR information; if the first IP address is the same as the second IP address, it indicates that the first data packet and the second data packet are data packets transmitted between a same terminal and the service provider.

Further, it may also be determined that time when the first data packet is transmitted between the terminal and the service provider is between time of establishing the air interface link and time of releasing the air interface link, so as to ensure that the first data packet and the second data packet are transmitted through a same air interface link. Further, if the first IP address is the same as the second IP address, the DPI information of the terminal is associated with the CHR information of the terminal, where the DPI information of the terminal is DPI information corresponding to the first data packet and the CHR information of the terminal is CHR information corresponding to the second data packet. In this way, it is ensured that the DPI information and the CHR information correspond to a same air interface link of a same terminal, thereby increasing accuracy of service analysis. The rest may be deduced in the same manner.

Associated DPI information and CHR information corresponding to different air interface links of a same terminal may be obtained, and the DPI information and the CHR information belonging to the same air interface link are associated. In addition, for different user terminals, the rest may be deduced in the same manner. Associated information of the DPI information and the CHR information of different user terminals may be obtained. It should be noted that during the specific implementation, to analyze a service more accurately, multiple terminals should be used as reference analysis objects. Therefore, at least one terminal is used to obtain associated DPI information and CHR information of the corresponding terminal.

S205. Perform, according to the DPI information of the terminal and the CHR information of the terminal that have been associated, analysis on a service transmitted between the terminal and the service provider.

In one feasible implementation manner, information related to the service may be determined by using the DPI information, and radio side information may be determined by using the CHR information. A KQI (key quality indicator) of each service is evaluated according to the DPI information, where the KQI is used to indicate quality of a service; and radio side factors that affect the KQI of each service are determined according to the associated DPI information and CHR information, preferably, radio side factors that cause an exception of the KQI of each service are determined. The following uses QQ login time as an example for description.

According to the DPI information, it may be determined that the service type is QQ service, and QQ login time may also be determined. This process is the prior art, which is not detailed herein by the present invention. When the QQ login time is greater than a preset threshold, it indicates that the KQI of the QQ is abnormal. According to the associated DPI information and CHR information, CHR information corresponding to the DPI information which is used to analyze an exception of the KQI of the QQ may be determined, and radio side factors that affect the exception of the KQI may be determined from the determined corresponding CHR information, and the located radio side factors are optimized to improve user experience in data services.

In another feasible implementation manner, information related to the service may be determined by using the DPI information, and radio side information may be determined by using the CHR information. Therefore, radio behavior feature information of each service transmitted between the terminal and the service provider is obtained according to the associated DPI information and CHR information corresponding to different air interface links. Further, the radio behavior feature information includes any one of the following information or a combination of multiple pieces of the following information: penetration of radio connections, penetration of radio switching times, penetration of radio called times, penetration of radio connection duration, penetration of radio traffic, radio connections per ELR (Erlang) within period, radio connections per traffic within period, switching times per ELR within period, switching times per traffic within period, called times per ELR within period, and called times per traffic within period.

It should be noted that the radio behavior feature information may include any one of the foregoing information or a combination of multiple pieces of the foregoing information but is not limited to the foregoing radio behavior feature information. In addition, the foregoing per traffic may be per GB (gigabyte) or per MB (megabyte) or per KB (kilobyte), and the like, which is not limited herein by the present invention. The following describes, by using the foregoing radio behavior feature information and according to the associated DPI information and CHR information, a process of performing analysis on a service transmitted between the terminal and the service provider.

For example, associating the DPI information with the CHR information obtains associated information that includes both the DPI information and the CHR information. Because the associated information is a recoding table that includes a large quantity of data, a penetration of radio connections of each service may be measured through the associated information corresponding to each terminal, and a frequency of air interface connection of each service may be evaluated according to the penetration of radio connections of each service, which is an important index that affects radio signaling resources.

For another example, associating the DPI information with the CHR information obtains associated information that includes both the DPI information and the CHR information. Because the associated information is a recoding table that includes a large quantity of data, a penetration of radio switching times of each service may be measured through the associated information corresponding to each terminal, and a frequency of radio switching of each service may be evaluated according to the penetration of radio switching times of each service, which is an important index that affects radio signaling resources.

For another example, associating the DPI information with the CHR information obtains associated information that includes both the DPI information and the CHR information. Because the associated information is a recoding table that includes a large quantity of data, a penetration of radio called times of each service may be measured through the associated information corresponding to each terminal, and a frequency of radio paging of each service may be evaluated according to the penetration of radio called times of each service, which is an important index that affects radio paging signaling resources.

For another example, associating the DPI information with the CHR information obtains associated information that includes both the DPI information and the CHR information. Because the associated information is a recoding table that includes a large quantity of data, a penetration of connection duration of each service may be measured through the associated information corresponding to each terminal, and a duration of occupying a service channel by each service may be evaluated according to the penetration of connection duration of each service, which is an important index that affects service resources.

For another example, associating the DPI information with the CHR information obtains associated information that includes both the DPI information and the CHR information. Because the associated information is a recoding table that includes a large quantity of data, a penetration of radio traffic of each service may be measured through the associated information corresponding to each terminal, and traffic of occupying a service channel by each service may be evaluated according to the penetration of radio traffic of each service, which is an important index that affects service resources.

For another example, associating the DPI information with the CHR information obtains associated information that includes both the DPI information and the CHR information. Because the associated information is a recoding table that includes a large quantity of data, radio connections per ELR (Erlang) within period of each service may be measured through the associated information corresponding to each terminal, and a frequency of air interface connection of each service may be evaluated according to the radio connections per ELR (Erlang) within period of each service, which is an important index that affects radio signaling resources.

For another example, associating the DPI information with the CHR information obtains associated information that includes both the DPI information and the CHR information. Because the associated information is a recoding table that includes a large quantity of data, radio connections per traffic within period of each service may be measured through the associated information corresponding to each terminal, and a frequency of air interface connection of each service may be evaluated according to the radio connections per traffic within period of each service, which is an important index that affects radio signaling resources.

For another example, associating the DPI information with the CHR information obtains associated information that includes both the DPI information and the CHR information. Because the associated information is a recoding table that includes a large quantity of data, switching times per ELR within period of each service may be measured by using the associated information corresponding to each terminal, and a frequency of radio switching of each service may be evaluated according to the switching times per ELR within period of each service, which is an important index that affects radio signaling resources.

For another example, associating the DPI information with the CHR information obtains associated information that includes both the DPI information and the CHR information. Because the associated information is a recoding table that includes a large quantity of data, switching times per traffic within period of each service may be measured through the associated information corresponding to each terminal, and a frequency of radio switching of each service may be evaluated according to the switching times per traffic within period of each service, which is an important index that affects radio signaling resources.

For another example, associating the DPI information with the CHR information obtains associated information that includes both the DPI information and the CHR information. Because the associated information is a recoding table that includes a large quantity of data, a called times per ELR within period of each service may be measured through the associated information corresponding to each terminal, and a frequency of radio paging of each service may be evaluated according to the called times per ELR within period of each service, which is an important index that affects radio paging signaling resources.

For another example, associating the DPI information with the CHR information obtains associated information that includes both the DPI information and the CHR information. Because the associated information is a recoding table that includes a large quantity of data, called times per traffic within period of each service may be measured through the associated information corresponding to each terminal, and a frequency of radio paging of each service may be evaluated according to the called times per traffic within period of each service, which is an important index that affects radio paging signaling resources.

In this embodiment, radio behavior feature information of each service may be obtained according to associated DPI information and CHR information; then, a radio engineer obtains the radio behavior feature information of each service, and performs network planning with reference to predicted future development of networks and future development of each service. In the following description, the radio behavior feature information is exemplarily the penetration of radio connections.

Assuming that at least one terminal which is used as a reference object has established an air interface link with the BSC for 10,000 times within one hour, 10,000 pieces of CHR information are obtained. In addition, DPI is performed on all first data packets transmitted between the terminal and the service provider for 1,000,000 times to obtain 1,000,000 pieces of DPI information, where 900,000 pieces of the DPI information are detected to have a microblog service. After the DPI information is associated with the CHR information, it may be known that 9,000 pieces of CHR information correspond to the 900,000 pieces of the DPI information having the microblog service.

In this way, it may be calculated that the penetration of radio connections of the microblog service is 90%; further, a frequency of air interface connection of the microblog service may be evaluated as follows according to the radio connection penetration of the microblog service of 90%: Nine air interface connections of ten air interface connections need to implement the microblog service, which indicates that a current user tends to use the microblog service. During network planning, if it is predicted that more numbers need to be allocated and that the user is more favorable to using the microblog service, more radio signaling resources may be planned and allocated to the microblog service during the network planning, to further improve service experience of the user and reduce an off-net customer ratio.

In the method for service analysis provided by the second embodiment of the present invention, DPI information and CHR information of a terminal are obtained, and a first IP address of a first data packet and a second IP address of a second data packet transmitted in an air interface link are obtained; if the first IP address is the same as the second IP address and time when the first data packet is transmitted between the terminal and a service provider is between time of establishing the air interface link and time of releasing the air interface link, the DPI information is associated with the CHR information to ensure that the associated DPI information and CHR information corresponds to a same air interface link of a same terminal, and analysis is performed, according to the associated information, on a service transmitted between the terminal and the service provider, so that radio side factors that affect data services can be quickly located and the radio side factors are optimized, which increases service quality of the data services and improves a working efficiency. In addition, this method can also provide a basis for evaluation on various data services and the radio side and guide a network provider to perform network optimization and planning, which further improves experience in the data services, reduces an off-net customer ratio, and increases benefits.

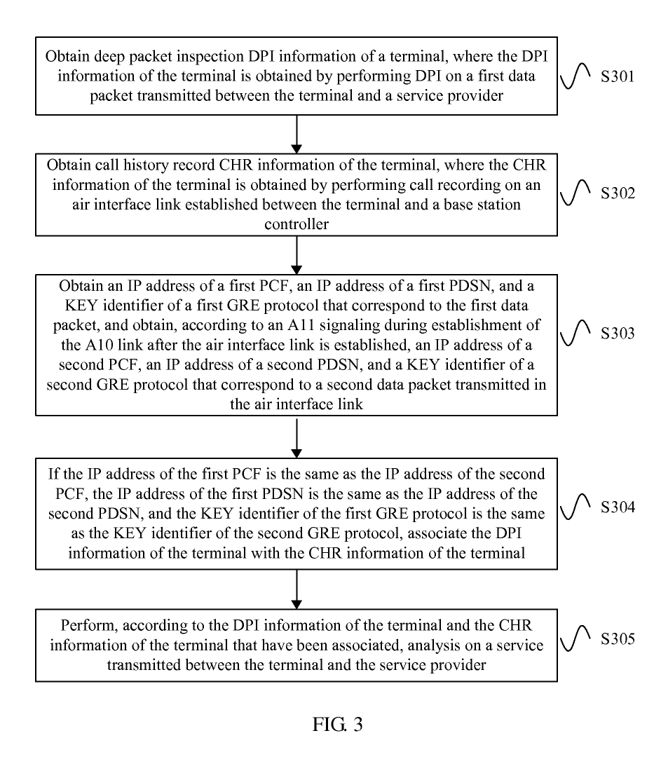

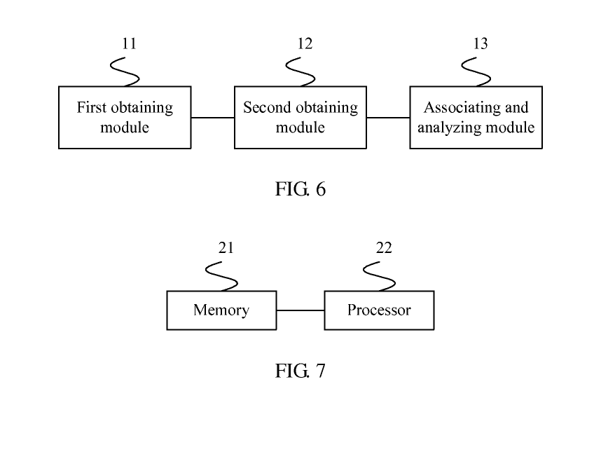

FIG. 3 is a flowchart of a third embodiment of a method for service analysis according to the present invention. As shown in FIG. 6, in this embodiment, DPI information may be associated with CHR information through an IP address of a PCF, an IP address of a PDSN, and a KEY identifier of the GRE protocol. The method may include the following steps.

S301. Obtain deep packet inspection DPI information of a terminal, where the DPI information of the terminal is obtained by performing DPI on a first data packet transmitted between the terminal and a service provider.

It should be noted that in this embodiment, DPI is performed on a first data packet transmitted in an A10 link between a PCF and a PDSN to obtain DPI information of the terminal.

S302. Obtain call history record CHR information of the terminal, where the CHR information of the terminal is obtained by performing call recording on an air interface link established between the terminal and a base station controller.

S303. Obtain an IP address of a first PCF, an IP address of a first PDSN, and a KEY identifier of a first GRE protocol that correspond to the first data packet, and obtain, according to an A11 signaling during establishment of the A10 link after the air interface link is established, an IP address of a second PCF, an IP address of a second PDSN, and a KEY identifier of a second GRE protocol that correspond to a second data packet transmitted in the air interface link.

During establishment of the A10 link, a PCF sends an A11 signaling to a PDSN, where the A11 signaling is used to indicate establishment of the A10 link and the A11 link includes an IP address of the PCF, an IP address of the PDSN, and a KEY identifier of the GRE (Generic Routing Encapsulation, Generic Routing Encapsulation) Protocol. Therefore, the PDSN can obtain the IP address of the PCF, the IP address of the PDSN, and the KEY identifier of the GRE protocol through the A11 signaling. Therefore, the PCF and the PDSN can perform GRE encapsulation on a received data packet to ensure that the data packet can be transferred on a network. In this case, the data packet that has undergone GRE encapsulation carries the IP address of the PCF, the IP address of the PDSN, and the KEY identifier of the GRE protocol. In addition, the PCF and the PDSN can perform GRE decapsulation on a data packet which is transmitted through the A10 link.

Therefore, only the data packet transmitted in the A10 link has the IP address of the PCF, the IP address of the PDSN, and the KEY identifier of the GRE protocol. Because the A10 link is established on the basis of the air interface link and the A10 link corresponds to the air interface link one by one, the PCF sends, according to the A11 signaling during the establishment of the A10 link after the air interface link is established, the IP address of the PCF, the IP address of the PDSN, and the KEY identifier of the GRE protocol that are included in the A11 signaling to a BSC; the BSC records the IP address of the PCF, the IP address of the PDSN, and the KEY identifier of the GRE protocol in the CHR information. Therefore, the CHR information corresponding to the air interface link may include the IP address of the PCF, the IP address of the PDSN, and the KEY identifier of the GRE protocol that are included in the A11 signaling corresponding to the air interface link.

In this embodiment, according to the DPI information obtained by performing DPI on the first data packet transmitted in the A10 link between the terminal and the service provider, the IP address of the first PCF, the IP address of the first PDSN, and the KEY identifier of the first GRE protocol in the first data packet can be obtained. According to CHR information of an air interface link, the IP address of the second PCF, the IP address of the second PDSN, and the KEY identifier of the second GRE protocol that correspond to a second data packet transmitted in the air interface can be obtained.

S304. If the IP address of the first PCF is the same as the IP address of the second PCF, the IP address of the first PDSN is the same as the IP address of the second PDSN, and the KEY identifier of the first GRE protocol is the same as the KEY identifier of the second GRE protocol, associate the DPI information of the terminal with the CHR information of the terminal.

Whether the IP address of the first PCF is the same as the IP address of the second PCF, whether the IP address of the first PDSN is the same as the IP address of the second PDSN, and whether the KEY identifier of the first GRE protocol is the same as the KEY identifier of the second GRE protocol are determined; if at least one of the foregoing determinations is negative, it indicates that the first data packet and the second data packet are data packets transmitted between different terminals and the service provider, and therefore the DPI information cannot be associated with the CHR information; if the IP address of the first PCF is the same as the IP address of the second PCF, the IP address of the first PDSN is the same as the IP address of the second PDSN, and the KEY identifier of the first GRE protocol is the same as the KEY identifier of the second GRE protocol, it indicates that the first data packet and the second data packet are data packets transmitted between a same terminal and the service provider.

Further, it may also be determined that time when the first data packet is transmitted between the terminal and the service provider is between time of establishing the air interface link and time of releasing the air interface link, so as to ensure that the first data packet and the second data packet are transmitted through a same air interface link. Further, if the IP address of the first PCF is the same as the IP address of the second PCF, the IP address of the first PDSN is the same as the IP address of the second PDSN, and the KEY identifier of the first GRE protocol is the same as the KEY identifier of the second GRE protocol, the DPI information of the terminal is associated with the CHR information of the terminal, where the DPI information of the terminal is DPI information corresponding to the first data packet, and the CHR information of the terminal is CHR information corresponding to the second data packet.

In this way, it is ensured that the DPI information and the CHR information correspond to a same air interface link, thereby increasing accuracy of service analysis. The rest may be deduced in the same manner. Associated DPI information and CHR information corresponding to different air interface links of a same terminal may be obtained, and the DPI information and the CHR information belonging to the same air interface link are associated.

S305. Perform, according to the DPI information of the terminal and the CHR information of the terminal that have been associated, analysis on a service transmitted between the terminal and the service provider.

In this embodiment, the specific implementation process of S305 is similar to the implementation process of S205 in the method for service analysis illustrated in the second embodiment of the present invention. For details, reference may be made to records in S205, which is not further described herein.

In the method for service analysis provided by the second embodiment of the present invention, DPI information and CHR information of a terminal are obtained, an IP address of a first PCF, an IP address of a first PDSN, and a KEY identifier of a first GRE protocol of a first data packet are obtained, and an IP address of a second PCF, an IP address of a second PDSN, and a KEY identifier of a second GRE protocol corresponding to a second data packet transmitted in the air interface link are obtained according to an A11 signaling during establishment of an A10 link after an air interface link is established; if the IP address of the first PCF is the same as the IP address of the second PCF, the IP address of the first PDSN is the same as the IP address of the second PDSN, and the KEY identifier of the first GRE protocol is the same as the KEY identifier of the second GRE protocol, and time when the first data packet is transmitted between the terminal and a service provider is between time of establishing the air interface link and time of releasing the air interface link, the DPI information is associated with the CHR information to ensure that the associated DPI information and CHR information corresponds to a same air interface link of a same terminal, and analysis is performed, according to the associated information, on a service transmitted between the terminal and the service provider, so that radio side factors that affect data services can be located and the radio side factors are optimized, which increases service quality of the data services and improves a working efficiency. This method can also provide a basis for evaluation on various data services and the radio side and guide a network provider to perform network optimization and planning, which further increases experience in the data services, reduces an off-net customer ratio, and increases benefits.

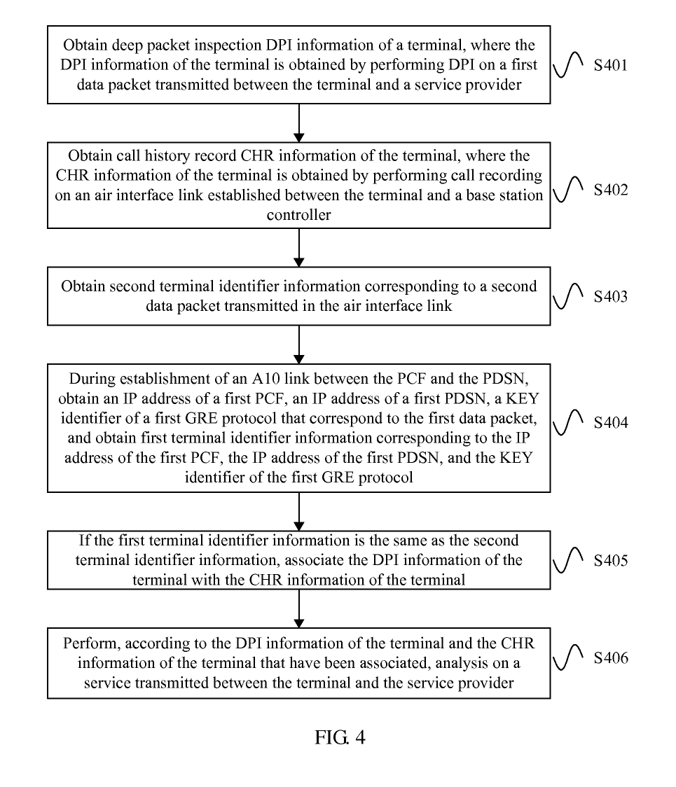

FIG. 4 is a flowchart of a fourth embodiment of a method for service analysis according to the present invention. As shown in FIG. 4, in this embodiment, terminal identifier information may be obtained according to an IP address of a PCF, an IP address of a PDSN, and a KEY identifier of the GRE protocol, and DPI information is associated with CHR information through the terminal identifier information. The method may include the following steps.

S401. Obtain deep packet inspection DPI information of a terminal, where the DPI information of the terminal is obtained by performing DPI on a first data packet transmitted between the terminal and a service provider.

It should be noted that in this embodiment, deep packet detection is performed on a first data packet transmitted in an A10 link between a PCF and a PDSN, so as to obtain DPI information of the terminal.

S402. Obtain call history record CHR information of the terminal, where the CHR information of the terminal is obtained by performing call recording on an air interface link established between the terminal and a base station controller.

S403. Obtain second terminal identifier information corresponding to a second data packet transmitted in the air interface link.

Because the CHR information records identifier information of a terminal that has established an air interface link with the BSC, terminal identifier information corresponding to a second data packet transmitted in the air interface link may be obtained according to the CHR information, where the identifier information is called second terminal identifier information.

S404. During establishment of the A10 link between the PCF and the PDSN, obtain an IP address of a first PCF, an IP address of a first PDSN, a KEY identifier of a first GRE protocol that correspond to the first data packet, and obtain first terminal identifier information corresponding to the IP address of the first PCF, the IP address of the first PDSN, and the KEY identifier of the first GRE protocol.

During the establishment of the A10 link between the PCF and the PDSN, the PCF needs to send an A11 signaling to the PDSN, where the A11 signaling is used to indicate establishment of an A10 link and the A11 signaling includes not only the IP address of the PCF, the IP address of the PDSN, and the KEY identifier of the GRE protocol but also the terminal identifier information. Therefore, the PDSN can obtain the IP address of the PCF, the IP address of the PDSN, the KEY identifier of the GRE protocol, and the terminal identifier information according to the A11 signaling. The terminal identifier information is information used to differentiate the terminal from other terminals. Persons of ordinary skill in the art can understand that when a user terminal is separable from a SIM (subscriber identity module) card, the terminal identifier information is an IMSI (international mobile subscriber identification number); when the user terminal is not separable from the SIM card, the terminal identifier information may be an IMSI or an ESN (electronic serial number), and the like. It should be noted that during the specific implementation, preferably, the identifier information of the terminal may be the IMSI.

In this embodiment, according to the DPI information obtained by performing DPI on the first data packet transmitted in the A10 link between the terminal and the service provider, the IP address of the first PCF, the IP address of the first PDSN, and the KEY identifier of the first GRE protocol in the first data packet can be obtained. Because the A10 link corresponds to the A11 signaling one by one, the terminal identifier information included in the A11 signaling can be determined, according to a fact that both the first data packet and the A11 signaling include the IP address of the first PCF, the IP address of the first PDSN, and the KEY identifier of the first GRE protocol, as the first terminal identifier information corresponding to the IP address of the first PCF, the IP address of the first PDSN, and the KEY identifier of the first GRE protocol included in the first data packet.

S405. If the first terminal identifier information is the same as the second terminal identifier information, associate the DPI information of the terminal with the CHR information of the terminal.

Whether the first terminal identifier information is the same as the second terminal identifier information is determined; if the first terminal identifier information is different from the second terminal identifier information, it indicates that the first data packet and the second data packet are data packets transmitted between different terminals and the service provider, and therefore the DPI information cannot be associated with the CHR information; if the first terminal identifier information is the same as the second terminal identifier information, it indicates that the first data packet and the second data packet are data packets transmitted between a same terminal and the service provider. Further, it may also be determined that time when the first data packet is transmitted between the terminal and the service provider is between time of establishing the air interface link and time of releasing the air interface link, so as to ensure that the first data packet and the second data packet are transmitted through a same air interface link.

Further, if the first terminal identifier information is the same as the second terminal identifier information, the DPI information of the terminal is associated with the CHR information of the terminal, where the DPI information of the terminal is DPI information corresponding to the first data packet, and the CHR information of the terminal is CHR information corresponding to the second data packet. In this way, it is ensured that the DPI information and the CHR information correspond to a same air interface link, thereby increasing accuracy of service analysis. The rest may be deduced in the same manner. Associated DPI information and CHR information corresponding to different air interface links of a same terminal may be obtained, and the DPI information and the CHR information belonging to the same air interface link are associated.

S406. Perform, according to the DPI information of the terminal and the CHR information of the terminal that have been associated, analysis on a service transmitted between the terminal and the service provider.

In this embodiment, the specific implementation process of S406 is similar to the implementation process of S205 in the method for service analysis illustrated in the second embodiment of the present invention. For details, reference may be made to records in S205, which is not further described herein.

In the method for service analysis provided by the fourth embodiment of the present invention, DPI information and CHR information of a terminal are obtained, second terminal identifier information corresponding to a second data packet transmitted in an air interface link is obtained, an IP address of a first PCF, an IP address of a first PDSN, and a KEY identifier of a first GRE protocol that correspond to the first data packet are obtained during establishment of an A10 link between a PCF and a PDSN, and first terminal identifier information corresponding to the IP address of the first PCF, the IP address of the first PDSN, and the KEY identifier of the first GRE protocol are obtained. If the first terminal identifier information is the same as the second terminal identifier information and time when the first data packet is transmitted between the terminal and a service provider is between time of establishing the air interface link and time of releasing the air interface link, the DPI information is associated with the CHR information to ensure that the associated DPI information and CHR information correspond to a same air interface link of a same terminal, and analysis is performed, according to the associated information, on a service transmitted between the terminal and the service provider, so that radio side factors that affect data services can be located and the radio side factors are optimized, which increases service quality of the data services and improves a working efficiency. This method can also provide a basis for evaluation on various data services and the radio side and guide a network provider to perform network optimization and planning, which further increases experience in the data services, reduces an off-net customer ratio, and increases benefits.

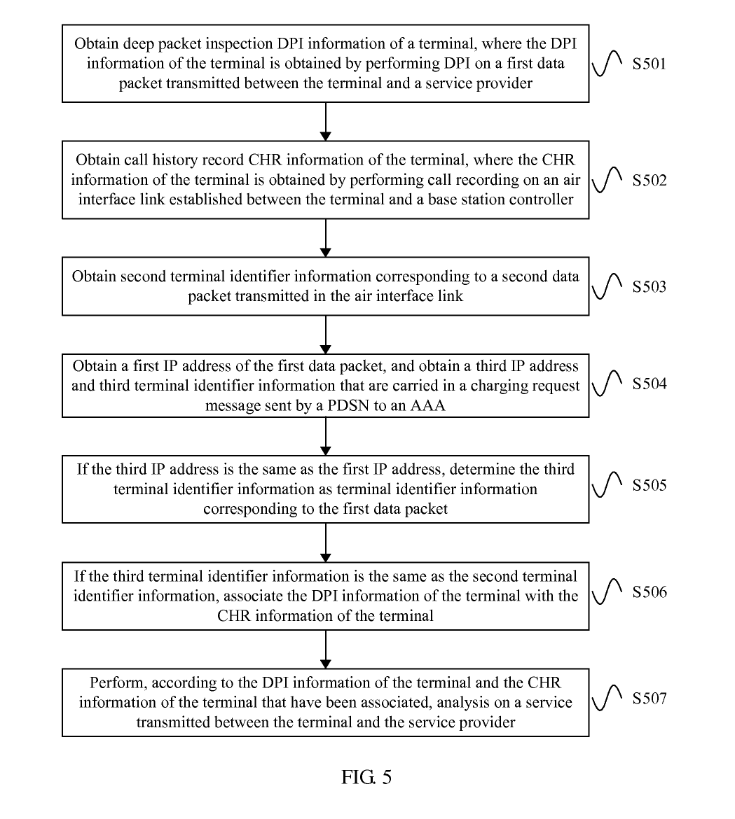

FIG. 5 is a flowchart of a fifth embodiment of a method for service analysis according to the present invention. As shown in FIG. 5, in this embodiment, terminal identifier information may be obtained according to an IP address of a terminal, and DPI information is associated with CHR information through the terminal identifier information. The method may include the following steps.

S501. Obtain deep packet inspection DPI information of a terminal, where the DPI information of the terminal is obtained by performing DPI on a first data packet transmitted between the terminal and a service provider.

S502. Obtain call history record CHR information of the terminal, where the CHR information of the terminal is obtained by performing call recording on an air interface link established between the terminal and a base station controller.

S503. Obtain second terminal identifier information corresponding to a second data packet transmitted in the air interface link.

S504. Obtain a first IP address of the first data packet, and obtain a third IP address and third terminal identifier information that are carried in a charging request message sent by a PDSN to an AAA.

A first IP address of the terminal in the first data packet may be obtained by using the DPI information of the terminal. To enable a telecom operator to charge the terminal that is implementing a service, the PDSN needs to send a charging request message to the AAA through a RADIUS packet, where the charging request message corresponding to the RADIUS packet includes terminal identifier information and the IP address of the terminal, and the AAA can charge the terminal corresponding to the terminal identifier information according to the charging request message. Therefore, the IP address and terminal identifier information of the terminal that implements the service may be obtained from the charging request message, which are called a third IP address and third terminal identifier information. Persons of ordinary skill in the art can understand that when a user terminal is separable from a SIM (subscriber identity module) card, the terminal identifier information may be an IMSI (international mobile subscriber identification number); and when the user terminal is not separable from the SIM card, the terminal identifier information may be an IMSI or an ESN (electronic serial number), and the like. It should be noted that during the specific implementation, preferably, the identifier information of the terminal may be the IMSI.

S505. If the third IP address is the same as the first IP address, determine the third terminal identifier information as terminal identifier information corresponding to the first data packet.

When a time difference between time when the first data packet is transmitted between the terminal and the service provider and time when the PDSN sends a charging request message to the AAA is the smallest and the third IP address is the same as the first IP address, it indicates that the charging request message is used to request charging the terminal that sends the first data packet. In this case, the third terminal identifier information in the charging request message that includes the first IP address is determined as terminal identifier information corresponding to the first data packet that includes the first IP address.

S506. If the third terminal identifier information is the same as the second terminal identifier information, associate the DPI information of the terminal with the CHR information of the terminal.

Whether the third terminal identifier information is the same as the second terminal identifier information is determined; if the third terminal identifier information is different from the second terminal identifier information, it indicates that the first data packet and the second data packet are data packets transmitted between different terminals and the service provider, and therefore the DPI information cannot be associated with the CHR information; if the third terminal identifier information is the same as the second terminal identifier information, it indicates that the first data packet and the second data packet are data packets transmitted between a same terminal and the service provider. Further, it may also be determined that time when the first data packet is transmitted between the terminal and the service provider is between time of establishing the air interface link and time of releasing the air interface link, so as to ensure that the first data packet and the second data packet are transmitted through a same air interface link.

In this case, the DPI information of the terminal is associated with the CHR information of the terminal, where the DPI information of the terminal is DPI information corresponding to the first data packet and the CHR information of the terminal is CHR information corresponding to the second data packet. In this way, it is ensured that the DPI information and the CHR information correspond to a same air interface link, thereby increasing accuracy of service analysis. The rest may be deduced in the same manner. Associated DPI information and CHR information corresponding to different air interface links of a same terminal may be obtained, and the DPI information and the CHR information belonging to the same air interface link are associated.

S507. Perform, according to the DPI information of the terminal and the CHR information of the terminal that have been associated, analysis on a service transmitted between the terminal and the service provider.

In this embodiment, the specific implementation process of S507 is similar to the implementation process of S205 in the method for service analysis illustrated in the second embodiment of the present invention. For details, reference may be made to records in S205, which is not further described herein.

In the method for service analysis provided in the fifth embodiment of the present invention, DPI information and CHR information of a terminal are obtained, second terminal identifier information corresponding to a second data packet transmitted in an air interface link is obtained, a first IP address of a first data packet is obtained, and a third IP address and third terminal identifier that are carried in a charging request message sent by a PDSN to an AAA are obtained; if the third IP address is the same as the first IP address, the third terminal identifier information is determined as terminal identifier information corresponding to the first data packet; if the third terminal identifier information is the same as the second terminal identifier information and time when the first data packet is transmitted between the terminal and a service provider is between time of establishing the air interface link and time of releasing the air interface link, the DPI information is associated with the CHR information to ensure that the associated DPI information and CHR information corresponds to a same air interface link of a same terminal, and analysis is performed, according to the associated information, on a service transmitted between the terminal and the service provider, so that radio side factors that affect data services can be located and the radio side factors are optimized, which increases service quality of the data services and improves a working efficiency. This method can also provide a basis for evaluation on various data services and the radio side and guide a network provider to perform network optimization and planning, which further increases experience in the data services, reduces an off-net customer ratio, and increases benefits.

FIG. 6 is a schematic structural diagram of a first embodiment of a device for service analysis according to the present invention. As shown in FIG. 6, the device for service analysis in this embodiment includes: a first obtaining module 11, a second obtaining module 12, and an associating and analyzing module 13. The first obtaining module 11 is configured to obtain deep packet inspection DPI information of a terminal, where the DPI information of the terminal is obtained by performing DPI on a first data packet transmitted between the terminal and a service provider. The second obtaining module 12 is configured to obtain call history record CHR information of the terminal, where the CHR information of the terminal is obtained by performing call recording on an air interface link established between the terminal and a base station controller. The associating and analyzing module 13 is configured to perform, according to the DPI information of the terminal and the CHR information of the terminal, analysis on a service transmitted between the terminal and the service provider.

The device for service analysis in this embodiment can be configured to execute the technical solution of the method embodiment illustrated in FIG. 1. The implementation principle of the device for service analysis is similar to that of the method embodiment illustrated in FIG. 1, which is not further described herein.

In the device for service analysis provided by the first embodiment of the present invention, a first obtaining module obtains DPI information of a terminal, a second obtaining module obtains CHR information of the terminal, and an associating and analyzing module performs, according to the DPI information and the CHR information, analysis on a service transmitted between the terminal and a service provider. In this way, radio side factors that affect data services can be located, and the radio side factors are optimized, thereby increasing service quality of the data services and improving a working efficiency.

In a second embodiment of a device for service analysis of the present invention, on the basis of the structure of the device for service analysis illustrated in FIG. 6, in a first feasible implementation manner, the foregoing associating and analyzing module 13 may be specifically configured to: obtain a first Internet Protocol IP address of a first data packet, and obtain a second IP address of a second data packet transmitted in an air interface link; it's the first IP address is the same as the second IP address, associate the DPI information of the terminal with the CHR information of the terminal; and perform, according to the DPI information of the terminal and the CHR information of the terminal that have been associated, analysis on the service transmitted between the terminal and the service provider.

In a second feasible implementation manner, the foregoing associating and analyzing module 13 may be specifically configured to: obtain an IP address of a first packet control function PCF, an IP address of a first packet data serving node PDSN, and a KEY identifier of a first Generic Routing Encapsulation GRE protocol that correspond to the first data packet, and obtain, according to an A11 signaling during establishment of an A10 link after the air interface link is established, an IP address of a second PCF, an IP address of a second PDSN, and a KEY identifier of a second GRE protocol that correspond to a second data packet transmitted in the air interface link; if the IP address of the first PCF is the same as the IP address of the second PCF, the IP address of the first PDSN is the same as the IP address of the second PDSN, and the KEY identifier of the first GRE protocol is the same as the KEY identifier of the second GRE protocol, associate the DPI information of the terminal with the CHR information of the terminal; and perform, according to the DPI information of the terminal and the CHR information of the terminal that have been associated, analysis on a service transmitted between the terminal and the service provider.

In a third feasible implementation manner, the foregoing associating and analyzing module 13 may be specifically configured to: obtain second terminal identifier information corresponding to a second data packet transmitted in the air interface link, obtain an IP address of a first PCF, an IP address of a first PDSN, and a KEY identifier of a first GRE protocol that correspond to the first data packet during establishment of an A10 link between the PCF and the PDSN, and obtain first terminal identifier information corresponding to the IP address of the first PCF, the IP address of the first PDSN, and the KEY identifier of the first GRE protocol; if the first terminal identifier information is the same as the second terminal identifier information, associate the DPI information of the terminal with the CHR information of the terminal; and perform, according to the DPI information of the terminal and the CHR information of the terminal that have been associated, analysis on the service transmitted between the terminal and the service provider.

In a fourth feasible implementation manner, the foregoing associating and analyzing module 13 may be specifically configured to: obtain second terminal identifier information corresponding to the second data packet transmitted in the air interface link, obtain the first IP address of a first data packet, and obtain a third IP address and third terminal identifier information that are carried in a charging request message sent by a PDSN to an Authentication, Authorization and Accounting AAA; if the third IP address is the same as the first IP address, determine the third terminal identifier information as terminal identifier information corresponding to the first data packet; if the third terminal identifier information is the same as the second terminal identifier information, associate the DPI information of the terminal with the CHR information of the terminal; and perform, according to the DPI information of the terminal and the CHR information of the terminal that have been associated, analysis on the service transmitted between the terminal and the service provider.

In any one of the foregoing feasible implementation manners, time when the first data packet is transmitted between the terminal and the service provider is between time of establishing the air interface link and time of releasing the air interface link. Further, the foregoing associating and analyzing module 13 may be specifically configured to: evaluate a key quality indicator KQI of the service according to the DPI information, where the KQI is used to indicate quality of the service, and determine, according to the DPI information of the terminal and the CHR information of the terminal that have been associated, radio side factors that affect the KQI of the service; or, obtain, according to the DPI information of the terminal and the CHR information of the terminal that have been associated, radio behavior feature information of each service transmitted between the terminal and the service provider. The radio behavior feature information includes any one of the following information or a combination of multiple pieces of the following information: penetration of radio connections, penetration of radio switching times, penetration of radio called times, penetration of radio connection duration, penetration of radio traffic, radio connections per Erlang ELR within period, radio connections per traffic within period, switching times per ELR within period, switching times per traffic within period, called times per ELR within period, and called times per traffic within period.

The device for service analysis in this embodiment can be configured to execute the technical solution of the method embodiment illustrated in any one of FIG. 2 to FIG. 5. The implementation principle of the device for service analysis is similar to that of the method embodiment illustrated in any one of FIG. 2 to FIG. 5, which is not further described herein.

In the device for service analysis provided by the second embodiment of the present invention, a first obtaining module in the device for service analysis obtains DPI information of a terminal, a second obtaining module obtains CHR information of the terminal, and an associating and analyzing module can determine, by using the foregoing four different implementation manners, that a first data packet and a second data packet correspond to a same terminal, and determines that time when the first data packet is transmitted between the terminal and a service provider is between time of establishing the air interface link and time of releasing the air interface link, so as to ensure that the first data packet and the second data packet correspond to a same air interface link of a same terminal; then, the associating and analyzing module associates the DPI information with the CHR information, and performs, according to the associated information, analysis on a service transmitted between the terminal and the service provider. In this way, radio side factors that affect data services can be located, and the radio side factors are optimized, which increases service quality of the data services and improves a working efficiency. In addition, a basis is provided for evaluation on various data services and the radio side, and a network provider is guided to perform network optimization and planning, which further improves experience in the data services, reduces an off-net customer ratio, and increases benefits.

FIG. 7 is a schematic structural diagram of a third embodiment of a device for service analysis according to the present invention. As shown in FIG. 7, the device for service analysis in this embodiment may include a memory 21 and a processor 22. The memory 21 is configured to store a code that executes a method for service analysis and the processor 22 is configured to execute the code stored in the memory 21, where the method for service analysis includes: obtaining deep packet inspection DPI information of a terminal, where the DPI information of the terminal is obtained by performing DPI on a first data packet transmitted between the terminal and a service provider; obtaining call history record CHR information of the terminal, where the CHR information of the terminal is obtained by performing call recording on an air interface link established between the terminal and a base station controller; and performing, according to the DPI information of the terminal and the CHR information of the terminal, analysis on a service transmitted between the terminal and the service provider.

The device for service analysis in this embodiment can be configured to execute the technical solution of the method embodiment illustrated in FIG. 1. The implementation principle of the device for service analysis is similar to that of the method embodiment illustrated in FIG. 1, which is not further described herein.

In the device for service analysis provided by the third embodiment of the present invention, a memory stores a code that executes a method for service analysis, and a processor executes the code stored in the memory, where the method for service analysis includes: obtaining DPI information and CHR information of a terminal, and performing, according to the DPI information and the CHR information, analysis on a service transmitted between the terminal and a service provider. In this way, radio side factors that affect data services can be located, and the radio side factors are optimized, which increases service quality of the data services and improves a working efficiency.

In a fourth embodiment of the device for service analysis, on the basis of the structure of the device for service analysis illustrated in FIG. 7, as a first feasible implementation manner, the performing, according to the DPI information of the terminal and the CHR information of the terminal, analysis on a service transmitted between the terminal and the service provider includes: obtaining a first Internet Protocol IP address of a first data packet, and obtaining a second IP address of a second data packet transmitted in the air interface link; if the first IP address is the same as the second IP address, associating the DPI information of the terminal with the CHR information of the terminal; and performing, according to the DPI information of the terminal and the CHR information of the terminal that have been associated, analysis on the service transmitted between the terminal and the service provider.

As a second feasible implementation manner, the performing, according to the DPI information of the terminal and the CHR information of the terminal, analysis on a service transmitted between the terminal and the service provider includes: obtaining an IP address of a first packet control function PCF, an IP address of a first packet data serving node PDSN, and a KEY identifier of a first Generic Routing Encapsulation GRE protocol that correspond to the first data packet, and obtaining, according to an A11 signaling during establishment of an A10 link after the air interface link is established, an IP address of a second PCF, an IP address of a second PDSN, and a KEY identifier of a second GRE protocol that correspond to a second data packet transmitted in the air interface link; if the IP address of the first PCF is the same as the IP address of the second PCF, the IP address of the first PDSN is the same as the IP address of the second PDSN, and the KEY identifier of the first GRE protocol is the same as the KEY identifier of the second GRE protocol, associating the DPI information of the terminal with the CHR information of the terminal; and performing, according to the DPI information of the terminal and the CHR information of the terminal that have been associated, analysis on the service transmitted between the terminal and the service provider.

As a third feasible implementation manner, the performing, according to the DPI information of the terminal and the CHR information of the terminal, analysis on a service transmitted between the terminal and the service provider includes: obtaining second terminal identifier information corresponding to a second data packet transmitted in the air interface link, obtaining an IP address of a first PCF, an IP address of a first PDSN, and a KEY identifier of a first GRE protocol that correspond to the first data packet during establishment of an A10 link between the PCF and the PDSN, and obtaining first terminal identifier information corresponding to the IP address of the first PCF, the IP address of the first PDSN, and the KEY identifier of the first GRE protocol; if the first terminal identifier information is the same as the second terminal identifier information, associating the DPI information of the terminal with the CHR information of the terminal; and performing, according to the DPI information of the terminal and the CHR information of the terminal that have been associated, analysis on a service transmitted between the terminal and the service provider.

As a fourth feasible implementation manner, the performing, according to the DPI information of the terminal and the CHR information of the terminal, analysis on a service transmitted between the terminal and the service provider includes: obtaining second terminal identifier information corresponding to a second data packet transmitted in the air interface link, obtaining a first IP address of the first data packet, and obtaining a third IP address and third terminal identifier information that are carried in a charging request message sent by a PDSN to an authentication, authorization, and accounting AAA; if the third IP address is the same as the first IP address, determining the third terminal identifier information as terminal identifier information corresponding to the first data packet; if the third terminal identifier information is the same as the second terminal identifier information, associating the DPI information of the terminal with the CHR information of the terminal; and performing, according to the DPI information of the terminal and the CHR information of the terminal that have been associated, analysis on the service transmitted between the terminal and the service provider.

On the basis of any one of the foregoing feasible implementation manners, time when the first data packet is transmitted between the terminal and the service provider is between time of establishing the air interface link and time of releasing the air interface link. Further, the performing, according to the DPI information of the terminal and the CHR information of the terminal that have been associated, analysis on the service transmitted between the terminal and the service provider includes: evaluating a key quality indicator KQI of the service according to the DPI information, where the KQI is used to indicate quality of the service, and determining, according to the DPI information of the terminal and the CHR information of the terminal that have been associated, radio side factors that affect the service; or, obtaining, according to the DPI information of the terminal and the CHR information of the terminal that have been associated, radio behavior feature information of each service transmitted between the terminal and the service provider. The radio behavior feature information includes any one of the following information or a combination of multiple pieces of the following information: penetration of radio connections, penetration of radio switching times, penetration of radio called times, penetration of radio connection duration, penetration of radio traffic, radio connections per Erlang ELR within period, radio connections per traffic within period, switching times per ELR within period, switching times per traffic within period, called times per ELR within period, and called times per traffic within period.

The device for service analysis in this embodiment can be configured to execute the technical solution of the method embodiment illustrated in any one of FIG. 2 to FIG. 5. The implementation principle of the device for service analysis is similar to that of the method embodiment illustrated in any one of FIG. 2 to FIG. 5, which is not further described herein.

In the device for service analysis provided by the fourth embodiment of the present invention, a memory stores a code that executes a method for service analysis, and a processor executes the code stored in the memory, where the method for service analysis includes: obtaining DPI information and CHR information of a terminal; determining, by using the foregoing four different implementation manners, that a first data packet and a second data packet correspond to a same terminal; determining that time when the first data packet is transmitted between the terminal and a service provider is between time of establishing the air interface link and time of releasing the air interface link, so as to ensure that the first data packet and the second data packet correspond to a same air interface link of a same terminal, and then associating the DPI information with the CHR information, and performing, according to the associated information, analysis on a service transmitted between the terminal and the service provider. In this way, radio side factors that affect data services can be located, and the radio side factors are optimized, which increases service quality of the data services and improves a working efficiency. In addition, a basis is provided for evaluation on various data services and the radio side, and a network provider is guided to perform network optimization and planning, which further improves experience in the data services, reduces an off-net customer ratio, and increases benefits.

Persons of ordinary skill in the art may understand that, all or a part of the steps of the foregoing method embodiments may be implemented by a program instructing relevant hardware. The foregoing programs may be stored in a computer readable storage medium. When the program runs, the foregoing steps of the foregoing method embodiments are performed. The foregoing storage medium includes any mediums capable of storing program codes, such as a ROM, a RAM, a magnetic disk, or an optical disc.

Finally, it should be noted that the foregoing embodiments are merely intended for describing the technical solutions of the present invention rather than limiting the present invention. Although the present invention is described in detail with reference to the foregoing embodiments, persons of ordinary skill in the art should understand that they may still make modifications to the technical solutions described in the foregoing embodiments, or make equivalent replacements to some technical features thereof, as long as such modifications or replacements do not cause the essence of corresponding technical solutions to depart from the spirit and scope of the technical solutions of the embodiments of the present invention.

What is claimed is:

1. A method for service analysis, comprising:
obtaining deep packet inspection (DPI) information of a terminal, wherein the DPI information of the terminal is obtained by performing DPI on a first data packet transmitted between the terminal and a service provider;
obtaining call history record (CHR) information of the terminal, wherein the CHR information of the terminal is obtained by performing call recording on an air interface link established between the terminal and a base station controller; and
performing analysis on a service transmitted between the terminal and the service provider, wherein the analysis is performed according to the DPI information of the terminal and the CHR information of the terminal.

2. The method according to claim 1, wherein time when the first data packet is transmitted between the terminal and the service provider is between a time of establishing the air interface link and a time of releasing the air interface link.

3. The method according to claim 1, wherein performing the analysis comprises:
obtaining a first Internet Protocol (IP) address of the first data packet;
obtaining a second IP address of a second data packet transmitted in the air interface link;
determining that the first IP address is the same as the second IP address;
associating the DPI information of the terminal with the CHR information of the terminal; and
performing analysis on the service transmitted between the terminal and the service provider, the analysis performed according to the DPI information of the terminal and the CHR information of the terminal that have been associated.

4. The method according to claim 3, wherein performing the analysis comprises:
evaluating a key quality indicator (KQI) of the service according to the DPI information, wherein the KQI is used to indicate quality of the service; and
determining radio side factors that affect the KQI of the service, the radio side factors being determined according to the DPI information of the terminal and the CHR information of the terminal that have been associated.

5. The method according to claim 3, wherein performing the analysis comprises obtaining radio behavior feature information of each service transmitted between the terminal and the service provider, wherein the radio behavior feature information is determined according to the DPI information of the terminal and the CHR information of the terminal that have been associated.

6. The method according to claim 5, wherein the radio behavior feature information comprises any one or more of: penetration of radio connections, penetration of radio switching times, penetration of radio called times, penetration of radio connection duration, penetration of radio traffic, radio connections per Erlang (ELR) within period, radio connections per traffic within period, switching times per ELR within period, switching times per traffic within period, called times per ELR within period, and called times per traffic within period.

7. A device for service analysis, comprising:
a first obtaining module, configured to obtain deep packet inspection (DPI) information of a terminal, wherein the DPI information of the terminal is obtained by performing DPI on a first data packet transmitted between the terminal and a service provider;
a second obtaining module, configured to obtain call history record (CHR) information of the terminal, wherein the CHR information of the terminal is obtained by performing call recording on an air interface link established between the terminal and a base station controller; and
an associating and analyzing module, configured to perform analysis on a service transmitted between the terminal and the service provider, the analysis being performed according to the DPI information of the terminal and the CHR information of the terminal.

8. The device according to claim 7, wherein the associating and analyzing module is configured to:
obtain an IP address of a first packet control function (PCF), an IP address of a first packet data serving node (PDSN), and a KEY identifier of a first Generic Routing Encapsulation (GRE) protocol that correspond to the first data packet, and obtain, according to an A11 signaling during establishment of an A10 link after the air interface link is established, an IP address of a second PCF, an IP address of a second PDSN, and a KEY identifier of a second GRE protocol that correspond to a second data packet transmitted in the air interface link;
determine that the IP address of the first PCF is the same as the IP address of the second PCF, the IP address of the first PDSN is the same as the IP address of the second PDSN, and the KEY identifier of the first GRE protocol is the same as the KEY identifier of the second GRE protocol;
associate the DPI information of the terminal with the CHR information of the terminal; and
perform analysis on the service transmitted between the terminal and the service provider, the analysis being performed according to the DPI information of the terminal and the CHR information of the terminal that have been associated.

9. The device according to claim 7, wherein a time when the first data packet is transmitted between the terminal and the service provider is between a time of establishing the air interface link and time of releasing the air interface link.

10. The device according to claim 7, wherein the associating and analyzing module is configured to:
obtain a first Internet Protocol (IP) address of the first data packet;
obtain a second IP address of a second data packet transmitted in the air interface link;
determine that the first IP address is the same as the second IP address;
associate the DPI information of the terminal with the CHR information of the terminal; and
perform analysis on the service transmitted between the terminal and the service provider, the analysis being performed according to the DPI information of the terminal and the CHR information of the terminal that have been associated.

11. The device according to claim 10, wherein the associating and analyzing module is further configured to evaluate a key quality indicator (KQI) of the service according to the DPI information, wherein the KQI is used to indicate quality of the service; and determine, according to the DPI information of the terminal and the CHR information of the terminal that have been associated, radio side factors that affect the KQI of the service.

12. The device according to claim 10, wherein the associating and analyzing module is further configured to obtain, according to the DPI information of the terminal and the CHR information of the terminal that have been associated, radio behavior feature information of each service transmitted between the terminal and the service provider.

13. The device according to claim 12, wherein the radio behavior feature information comprises one or more of: penetration of radio connections, penetration of radio switching times, penetration of radio called times, penetration of radio connection duration, penetration of radio traffic, radio connections per Erlang (ELR) within period, radio connections per traffic within period, switching times per ELR within period, switching times per traffic within period, called times per ELR within period, and called times per traffic within period.

14. A device for service analysis, comprising:
a memory; and
a processor coupled to the memory, wherein the processor is configured to execute a code stored in the memory, the code comprising instructions for:
obtaining deep packet inspection (DPI) information of a terminal, wherein the DPI information of the terminal is obtained by performing DPI on a first data packet transmitted between the terminal and a service provider;
obtaining call history record (CHR) information of the terminal, wherein the CHR information of the terminal is obtained by performing call recording on an air interface link established between the terminal and a base station controller; and
performing analysis on a service transmitted between the terminal and the service provider, wherein the analysis is performed according to the DPI information of the terminal and the CHR information of the terminal.

15. The device according to claim 14, wherein performing the analysis comprises:
obtaining an IP address of a first packet control function (PCF), an IP address of a first packet data serving node (PDSN), and a KEY identifier of a first Generic Routing Encapsulation (GRE) protocol that correspond to the first data packet;
obtaining, according to an A11 signaling during establishment of an A10 link after the air interface link is established, an IP address of a second PCF, an IP address of a second PDSN, and a KEY identifier of a second GRE protocol that correspond to a second data packet transmitted in the air interface link;
determining that the IP address of the first PCF is the same as the IP address of the second PCF, the IP address of the first PDSN is the same as the IP address of the second PDSN, and the KEY identifier of the first GRE protocol is the same as the KEY identifier of the second GRE protocol;
associating the DPI information of the terminal with the CHR information of the terminal; and
performing analysis on the service transmitted between the terminal and the service provider, wherein the analysis is performed according to the DPI information of the terminal and the CHR information of the terminal that have been associated.

16. The device according to claim 14, wherein a time when the first data packet is transmitted between the terminal and the service provider is between a time of establishing the air interface link and time of releasing the air interface link.

17. The device according to claim 14, wherein performing the analysis comprises:
obtaining a first Internet Protocol (IP) address of the first data packet;
obtaining a second IP address of a second data packet transmitted in the air interface link;
determining that the first IP address is the same as the second IP address;
associating the DPI information of the terminal with the CHR information of the terminal; and
performing analysis on the service transmitted between the terminal and the service provider, wherein the analysis is performed according to the DPI information of the terminal and the CHR information of the terminal that have been associated.

18. The device according to claim 17, wherein performing the analysis comprises evaluating a key quality indicator (KQI) of the service according to the DPI information, wherein the KQI is used to indicate quality of the service and determining, according to the DPI information of the terminal and the CHR information of the terminal that have been associated, radio side factors that affect the KQI of the service.

19. The device according to claim 17, wherein performing the analysis comprises obtaining, according to the DPI information of the terminal and the CHR information of the terminal that have been associated, radio behavior feature information of each service transmitted between the terminal and the service provider.

20. The device according to claim 19, wherein the radio behavior feature information comprises any one or more of: penetration of radio connections, penetration of radio switching times, penetration of radio called times, penetration of radio connection duration, penetration of radio traffic, radio connections per Erlang (ELR) within period, radio connections per traffic within period, switching times per ELR within period, switching times per traffic within period, called times per ELR within period, and called times per traffic within period.
